(19) United States
(12) Patent Application Publication
(10) Pub. No.: US 2023/0097665 A1
(43) Pub. Date: Mar. 30, 2023

(54) TAG DOMAIN PRESENTATION DEVICE, TAG DOMAIN PRESENTATION METHOD, AND INFORMATION PROCESSING SYSTEM USING THE SAME

(71) Applicant: Hitachi, Ltd., Tokyo (JP)

(72) Inventors: Hiroaki MASUDA, Tokyo (JP); Jumpei OKOSHI, Tokyo (JP); Tsunehiko BABA, Tokyo (JP)

(73) Assignee: Hitachi, Ltd., Tokyo (JP)

(21) Appl. No.: 17/439,147

(22) PCT Filed: Nov. 25, 2020
(86) PCT No.: PCT/JP2020/043909

§ 371 Date: Sep. 14, 2021

(51) Int. Cl. G06F 16/9032

(52) U.S. Cl. CPC G06F 16/9032

(57) ABSTRACT

A tag domain presentation device holds a data usage log table that stores a department to which a user belongs, information about an application for each user, a search tag used by the application, data information corresponding to the search tag, a given tag corresponding to each data piece, and user evaluation information related to the given tag. The tag domain presentation device generates a usage viewpoint extraction log table that is filtered from a data usage viewpoint from a record of the data usage log table, and generates a usage tendency evaluation table from the usage viewpoint extraction log table based on usage information about the user and the application for each department of the data and the user evaluation information, and presents a search formula of the tag for each department common as a data usage viewpoint based on the information.

### TECHNICAL FIELD

The present invention relates to a tag domain presentation device and a tag domain presentation method, and in particular, relates to a technology suitable for providing a unified tag search formula regardless of a department to search without a lot of man-hours by a data lake administrator who is provided with a function of searching information by tag related to data for a user who searches by a data lake.

### BACKGROUND ART

In recent years, with the progress of hardware technology and information processing technology, data analysis and AI utilization cases are increasing, and a need to use more data is increasing. Conventionally, in order that data that has been managed by each department in a corporate entity, and siloed (a state in which any department of a company independently carries out its own business without sharing information or collaborating with other departments and is isolated) can be used across the departments, there is a trend to consolidate the data of each department in the data lake. In this case, the data lake is a place to store structured data and unstructured data, which is a centralized storage of data in an environment where data collected from various data sources is managed and pre-processed for utilization.

However, in order to properly use the data lake in such a corporate entity, it is necessary that the data can be found and used by complying with management rules and assigning appropriate business metadata (tag) to each data piece. Generally, the data for each department is given a tag given based on unique information for each department, and has a different definition. Therefore, the data manager who manages the data lake needs to identify a common range of a range expressed by the search formula of the combination of tags defined for each department, and grant a unified tag that can be used across the departments to the common range. The data user provides such a unified tag to the user, and the user uses the unified tag so that the user can access the data with the tag to be searched by the user across the departments.

Such an information search technique is disclosed in, for example, PTL 1. In the system disclosed in PTL 1, non-standard features are identified from unique names that do not uniquely identify a standard name of the entity, and extra string is deleted, and each individual name is processed by use of the selected regular expression adjusted to use the name according to standard name format. As a result, the standard name of the entity is automatically corrected.

In this way, with the use of the technology disclosed in PTL 1, a dictionary for existing tags is referred to, and words that are not common items are deleted so that the tags for each department in the company can be automatically unified. As a result, it is expected that the administrator will reduce the man-hours when unifying the tags for each department.

### CITATION LIST

### Patent Literature

PTL 1: U.S. Pat. No. 9,542,456

### SUMMARY OF INVENTION

### Technical Problem

For example, in the industrial field, it is expected that the utilization of data lakes will be promoted toward the cross-sectoral use of data. In that case, the efficiency of data utilization will be improved by using a data catalog that supports the discovery and use of data on the data lake.

In such an environment, the data that has been previously managed independently is stored in the form of being transferred to the data lake. At that time, the tags created and assigned based on the unique information of each department are not standardized, and the definition is different. It is expected that it is difficult for the data lake administrator who does not satisfactorily grasp the understanding of data and a use method (how to handle the data for each department) to map the data stored in the data lake and the tag defined for each department between each department. Therefore, it can be expressed by a tag search formula that can cross the tag of each department through hearing with the data user of each department, and a data range is found, and the data range is extracted to try to give a unified tag. However, in such a case, the management manpower of the data lake administrator by hearing increases.

According to PTL 1, non-standard features can be identified from different tag names for each department and standardized by removing extra strings, but standardization of names with different expressions is not mentioned. Therefore, in an environment where a definition is made by a name that does not have a common feature representation, a reduction in such an effort of the data rake administrator when trying to provide a unified cross-sectoral tag is not considered.

An object of the present invention is to provide a method in which a data lake administrator, who is provided with a function of searching information by a tag related to data, is capable of providing a user who searches by a data lake with a search formula caused by a unified tag regardless of a search department without man-hours.

### Solution to Problem

The configuration of a tag domain presenting device according to the present invention is preferably a tag domain presentation device that presents a cross-sectoral tag search formula to each department that uses data to which a tag for searching is given. The tag domain presentation device holds a user attribute table that associates a user with a department of the user, a unique tag table that stores correspondence information between the tag and the data for each department, and a data usage log table that stores the department to which the user belongs, information about application software for each user, a search tag used by the application software, data information corresponding to the search tag, a given tag corresponding to each data piece indicated by the unique tag table, and user evaluation information about the given tag. The tag domain presentation device generates a usage viewpoint extraction log table that is filtered from a data usage viewpoint by the application software from a record of the data usage log table, generates a usage tendency evaluation table from a usage viewpoint extraction log table based on usage information about the user and the application software for each department of the data and the user evaluation information, and presents a search formula of the tag for each department common as a data usage viewpoint based on the information of the usage tendency evaluation table.

### Advantageous Effects of Invention

According to the present invention, there can be provided a method in which a data lake administrator, who is provided with a function of searching information by a tag related to data, is capable of providing a user who searches by a data lake with a search formula caused by a unified tag regardless of a search department without man-hours.

### BRIEF DESCRIPTION OF DRAWINGS

FIG. 1 is an overall configuration diagram of an information processing system according to an embodiment.

FIG. 2 is a functional configuration diagram of a data lake management server.

FIG. 3 is a functional configuration diagram of a data catalog management unit.

FIG. 4 is a functional configuration diagram of an administrator terminal.

FIG. 5 is a functional configuration diagram of a tag domain presentation device.

FIG. 6 is a functional configuration diagram of a data usage log management unit.

FIG. 7 is a functional configuration diagram of a user attribute management unit.

FIG. 8 is a functional configuration diagram of a tag domain management unit.

FIG. 9 is a functional configuration diagram of an application management unit.

FIG. 10 is a configuration diagram of hardware and software of the tag domain presentation device.

FIG. 11 is a diagram showing an example of a data usage log table.

FIG. 12 is a diagram showing an example of a usage viewpoint extraction log table.

FIG. 13 is a diagram showing an example of a unique tag table.

FIG. 14A is a diagram showing an example of an application table.

FIG. 14B is a diagram showing an example of an application parameter information table.

FIG. 15A is a diagram showing an example of a user attribute table.

FIG. 15B is a diagram showing an example of a user attribute weight table.

FIG. 16 is a diagram showing an example of a usage tendency evaluation table.

FIG. 17 is a diagram showing an example of a tag domain recommended value table.

FIG. 18 is a diagram showing an example of a recommended domain table.

FIG. 19A is a diagram illustrating a type of area division of a tag domain (TYPE A).

FIG. 19B is a diagram illustrating a type of area division of a tag domain (TYPE B).

FIG. 20 is a flowchart showing a series of processes from the accumulation of data usage logs to the presentation of the tag domain to the data lake administrator.

FIG. 21A is a flowchart showing a process of calculating similarity between records of the data usage logs (Part. 1).

FIG. 21B is a flowchart showing the process of calculating the similarity between records of the data usage logs (Part 2).

FIG. 22 is a flowchart showing the process of presenting the tag domain to the data lake administrator.

FIG. 23 is a flowchart showing the process of extracting the recommended tag domain.

FIG. 24 is a diagram showing an example of a tag domain recommendation screen.

### DESCRIPTION OF EMBODIMENTS

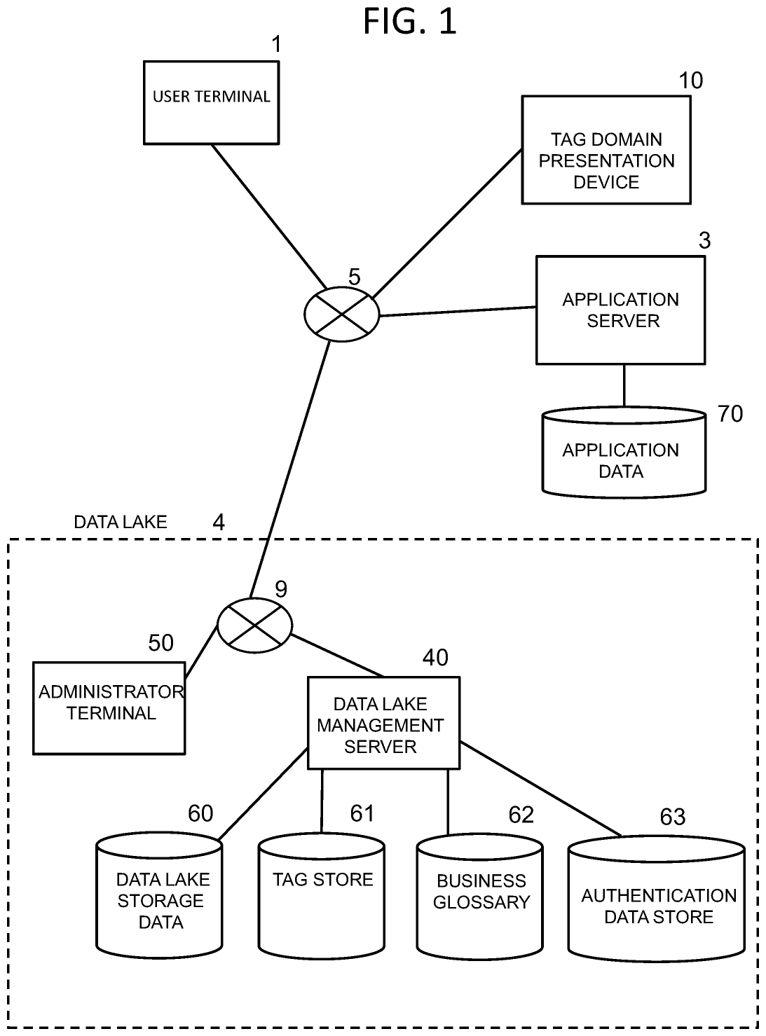

Hereinafter, an embodiment according to the present invention will be described with reference to FIGS. 1 to 24.

The present embodiment is an example in which a data administrator can provide a unified tag search formula common among departments in a search formula of data represented by the tag indicated by the search formula by the combination of tags when data is generated for each department, and data to which a tag with a different definition is given for each department is stored in a data lake. In the present embodiment, a site of a factory IoT (Internet Of Thing) in one company will be described as an example.

Now, first, the definitions used in the present specification will be described.

“Tag” is information of metadata related to being added to the data. For example, a tag “Shindo_Sensor” can be added to a specification manual, an accident case, operation history data, measurement data, and so on for a vibration sensor used in the factory.

A “unique tag” is a tag given based on the unique information of each department of a corporate entity. Whenever the term “unique tag” is used in the present specification, the department that defines the unique tag is always recognized.

A “Tag domain” is a conceptual range of search expressed by a search formula for a combination of the unique tags.

A “unified tag” is a tag given so that a data lake administrator can find a conceptual common range and perform a cross-sectoral search with respect to multiple “tag domains”.

First, a configuration of an information processing system according to the embodiment will be described with reference to FIGS. 1 to 10.

As shown in FIG. 1, the information processing system according to the present embodiment is configured so that a user terminal 1, a data lake 4, an application server 3, and a tag domain presentation device 10 are connected to each other by a network 5. The network 5 may be a LAN (Local Network) or may be a global network such as Internet.

The user terminal 1 is a terminal device for a user who instructs to execute application software to input commands and data and check information from the system. The data rake 4 is a place for storing structured data and unstructured data, which is a system that manages data collected from various data sources, and provides an environment that can perform preprocessing for utilization. The user can use the data accumulated in the data lake 4 by APIs among application software to be used, data search software, or the like. The application server 3 is a server device that executes the application software for processing data. The application server 3 holds application data 70 to be used in the application software. The tag domain presentation device 10 is a device that presents multiple tag domains that give a unified tag to the data rake administrator.

The data lake 4 has a configuration in which a data lake management server 40 and an administrator terminal 50 are connected to each other by a network 9. The network 9 may be a LAN or a global network.

The data lake management server 40 is a server device for managing the data in the data lake and its meta data (data given to the data handled in the data lake) and providing the data and the meta data to the outside. The data lake management server 40 manages data lake accumulation data 60, a tag store 61, a business glossary 62, and an authentication data store 63. The data lake accumulation data 60 is data to be provided as the data lake, and may be structured data such as RDB (Relational DataBase) or unstructured data such as measurement data of a sensor used in IoT (Internet of Things). The tag store 61 is data store that holds a correspondence between the tags given for searching and the data with respect to the data lake accumulation data 60. The business glossary 62 is a term dictionary defined as a norm in a corporate entity. In the present embodiment, the business glossary 62 is used to check the degree of matching of the terms and tags defined in the business glossary 62 (details will be described later). The authentication data store 63 is a data store that stores the user's authentication information.

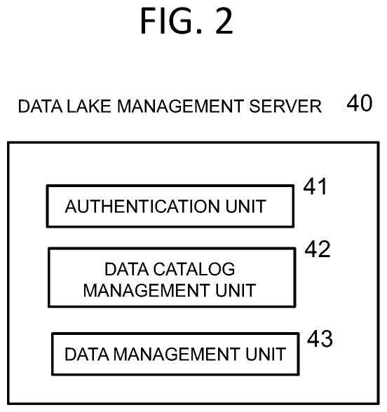

Next, the functional configuration of each component of the information processing system will be described with reference to FIGS. 2 to 10.

First, the functional configuration of the data lake management server will be described with reference to FIG. 2.

As shown in FIG. 2, the data lake management server 40 includes the respective functional units of an authentication unit 41, a data catalog management unit 42, and a data management unit 43.

The authentication unit 41 is a functional unit that authenticates the authority of a person who accesses a data catalog and data in the data lake. The data catalog management unit 42 is a functional unit that manages the data catalog in the data lake. In this example, the data catalog is a dictionary for data owned by a company, and in the present embodiment, specifically, the data catalog is the tag store 61 and the business glossary 62. The data management unit 43 is a functional unit that manages the data lake accumulation data 60 which is data accumulated and handled in the data lake.

In the present embodiment, the application server 3 outside the data lake 4 is used, but the application server 3 may be included inside the data lake 4 and integrated with the data lake management server 40.

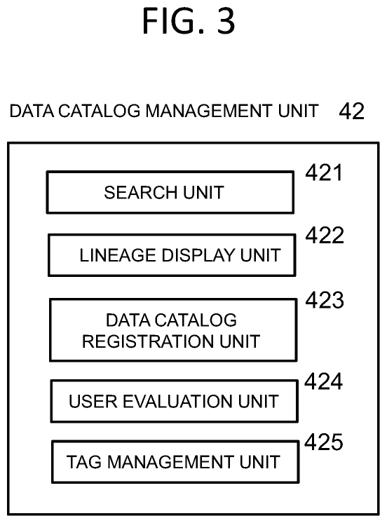

Next, a more detailed functional configuration of the data catalog management unit will be described with reference to FIG. 3.

As shown in FIG. 3, the data catalog management unit 42 of the data lake management server 40 includes the respective sub-functional units of a search unit 421, a lineage display unit 422, a data catalog registration unit 423, a user evaluation unit 424, and a tag management unit 425.

The search unit 421 is a functional unit that provides a data search function by tag. The lineage display unit 422 is a functional unit that generates display data of the usage history of data. The data catalog registration unit 423 is a functional unit that registers the tag for data, etc., in the data catalog. The user evaluation unit 424 is a functional unit that provides a function to perform user evaluation of search by tag. The tag management unit 425 is a functional unit that manages the tag of the tag store 61 in the data lake.

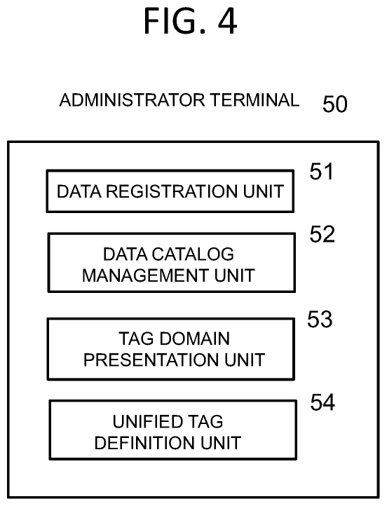

Next, the functional configuration of the administrator terminal will be described with reference to FIG. 4.

As shown in FIG. 4, the administrator terminal 50 includes the respective functional units of a data registration unit 51, a data catalog management unit 52, a tag domain presentation unit 53, and a unified tag definition unit 54.

The data registration unit 51 is a functional unit that registers the data handled by the data lake in the data lake accumulation data 60. The data catalog management unit 52 is a functional unit that manages the data catalog handled by the data lake. The tag domain presentation unit 53 is a functional unit that presents candidates for tag domains that have a conceptual commonality from the viewpoint of data usage to the data lake administrator. The unified tag definition unit 54 is a functional unit that supports defining a unified tag for the presented tag domain.

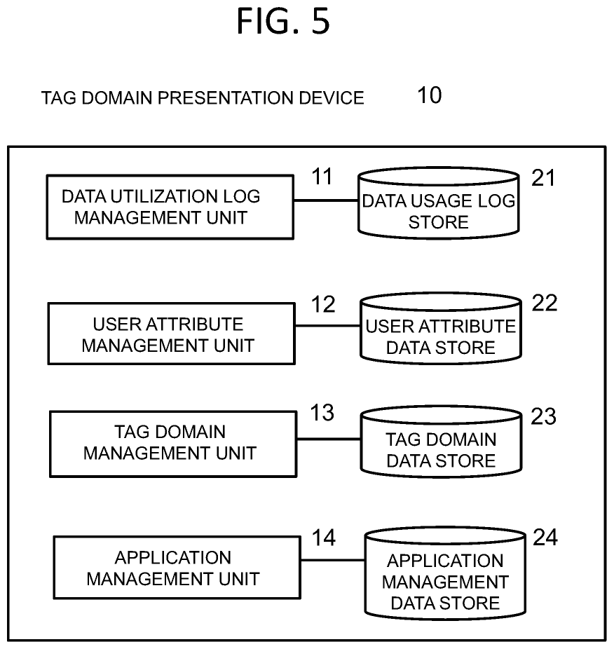

Next, the functional configuration of the tag domain presentation device will be described with reference to FIG. 5.

As shown in FIG. 5, the tag domain presentation device 10 includes the functional configuration units of a data usage log management unit 11, a user attribute management unit 12, a tag domain management unit 13, and an application management unit 14, and the functional configuration units hold a data usage log store 21, a user attribute store 22, a tag domain store 23, and an application management store 24, respectively.

A table included in each data store will be described in detail later.

The data usage log management unit 11 is a functional unit that manages the history information using the search by the tag from the user or application software. The user attribute management unit 11 is a functional unit that manages the information related to the user attribute. The domain management unit 13 is a functional unit that seeks and manages tag domains that have conceptual commonalities from the viewpoint of certain data usage. The application management unit 14 is a functional unit that manages information of an application used when seeking the tag domains that have conceptual commonalities from the viewpoint of certain data usage.

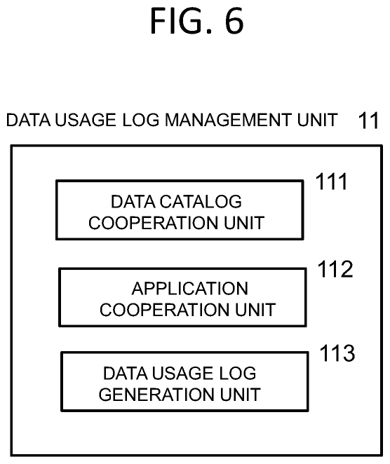

Next, a more detailed functional configuration of the data usage log management unit will be described with reference to FIG. 6.

As shown in FIG. 6, the data usage log management unit 11 of the tag domain presentation device 10 includes the respective sub-functional units of a data catalog cooperation unit 111, an application cooperation unit 112, and a data usage log generation unit 113.

The data catalog cooperation unit 111 is a functional unit that cooperates with the data catalog management unit 42 of the data lake management server 40 to access the data catalog information. The application cooperation unit 112 is an application management unit that cooperates with the application management unit 14 and acquires information of the application software. The data usage log generation unit 113 is a functional unit that generates data usage log information.

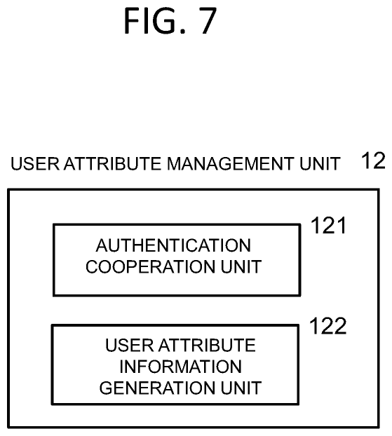

As shown in FIG. 7, the user attribute management unit 12 of the tag domain presentation device 10 includes the respective sub-functional units of an authentication cooperation unit 121 and a user attribute information generation unit 121. The authentication cooperation unit 121 is a functional unit that cooperates with the authentication units 41 of the data lake management server 40, accesses user authentication information, and acquires user profile information. The user attribute information generation unit 121 is a functional unit that generates user attribute information based on user profile information. The user attribute information generation unit 121, for example, associates a user ID with the user's department, and a user roll based on the user's profile information, and generates user attribute data. The user attribute information generation unit 121 registers as the user roll, for example, the business rolls like “engineer”, “researcher”, “section manager”, or “department manager”. Also, the user roll may map a business roll of an organization to the user roll (“Engineer”, “Analyst”, “Data Scientist”, and “Data Steward”) in the data management.

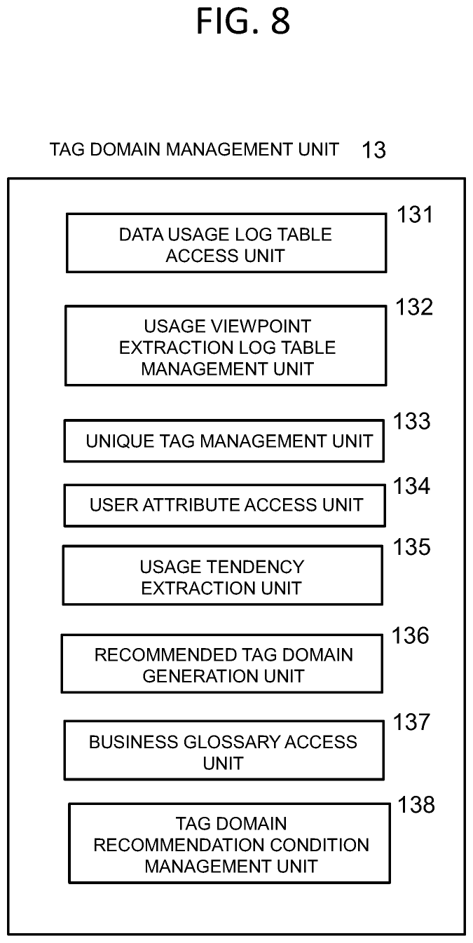

As shown in FIG. 8, the tag domain management unit 13 of the tag domain presentation device 10 includes the respective sub-functional units of a data usage log table access unit 131, a usage viewpoint extraction log table management unit 132, a unique tag management unit 133, a user attribute access unit 134, a usage tendency extraction unit 135, a recommended tag domain generation unit 136, a business glossary access unit 137, and a tag domain recommendation condition management unit 138.

The data usage log table access unit 131 is a functional unit that accesses the data usage log table (described later). The usage viewpoint extraction log table management unit 132 is a functional unit that generates and manages the usage viewpoint extraction log table (described later). The unique tag management unit 133 is a functional unit that manages unique tags used to present candidates for the tag domains that have conceptual commonalities from the viewpoint of data usage. The user attribute access unit 134 is a functional unit that accesses user attribute information. The usage tendency extraction unit 135 is a functional unit that extracts information on a usage tendency of unique tags from the viewpoint of use from the users and application software. The recommended tag domain generation unit 136 is a functional part that generates a tag domain that is recommended as a candidate for a tag domain that has a conceptual commonality from the viewpoint of data usage. The business glossary access unit 137 is a functional unit that accesses the business glossary 62 in the data rake. The tag domain recommendation condition management unit 138 is a functional unit that manages the conditions for generating the tag domain recommended as a candidate for the tag domain that has a conceptual commonality from the viewpoint of a certain data usage.

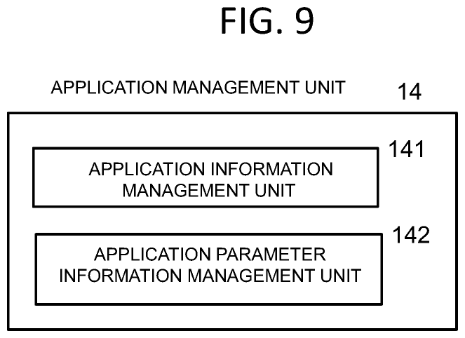

As shown in FIG. 9, the application management unit 14 of the tag domain presentation device 10 includes the respective sub-functional units of an application information management unit 141 and an application parameter information management unit 14.

The application information management unit 141 is a functional unit that manages information related to the application software. The application parameter information management unit 142 is a functional unit that manages information related to a parameter which is passed when the application software is executed.

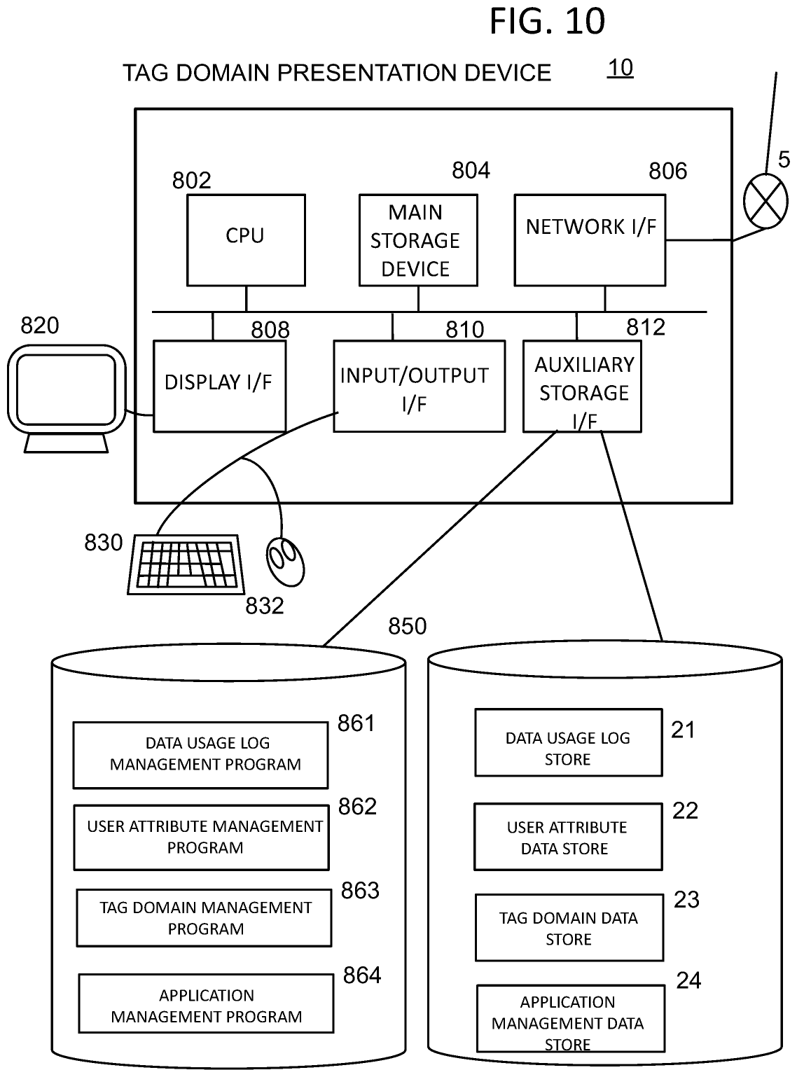

Next, the hardware and software configurations of the tag domain presentation device will be described with reference to FIG. 10.

The hardware configuration of the tag domain presentation device 10 is realized by, for example, a general information processing device such as a personal computer shown in FIG. 10.

In the tag domain presentation device 10, a CPU (Central Processing Unit) 802, a main storage device 804, a network I/F (InterFace) 806, a display I/F 808, an input/output I/F 810, and an auxiliary storage I/F 812 are coupled to each other by a bus.

The CPU 802 controls each unit of the tag domain presentation device 10 and loads and executes a program required for the main storage device 804.

The main memory 804 is configured by with volatile memory such as a RAM, and is stored with a program executed by the CPU 802 and the data to be referenced.

The network I/F 806 is an interface for connecting to the network 5.

The display I/F 808 is an interface for connecting a display device 820 such as an LCD (Liquid Crystal Display).

The input/output I/F 810 is an interface for connecting the input/output device. In an example of FIG. 10, the input/output I/F 810 is connected with a keyboard 830 and a pointing device mouse 832.

The auxiliary storage I/F 812 is an interface for connecting auxiliary storage devices such as an HDD (Hard Disk Drive) 850 and an SSD (Solid State Drive).

The HDD 850 has a large storage capacity and stores a program for executing the present embodiment. The tag domain presentation device 10 is installed with a data usage log management program 861, a user attribute management program 862, a tag domain management program 863, and an application management program 864.

The data usage log management program 861, the user attribute management program 862, the tag domain management program 863, and the application management program 864 are programs for realizing the functions of the data usage log management unit 11, the user attribute management unit 12, the tag domain management unit 13, and the application management unit 14, respectively.

In addition, the HDD 850 of the tag domain presentation device 10 holds the data usage log store 21, the user attribute store 22, the tag domain store 23, and the application management store 24.

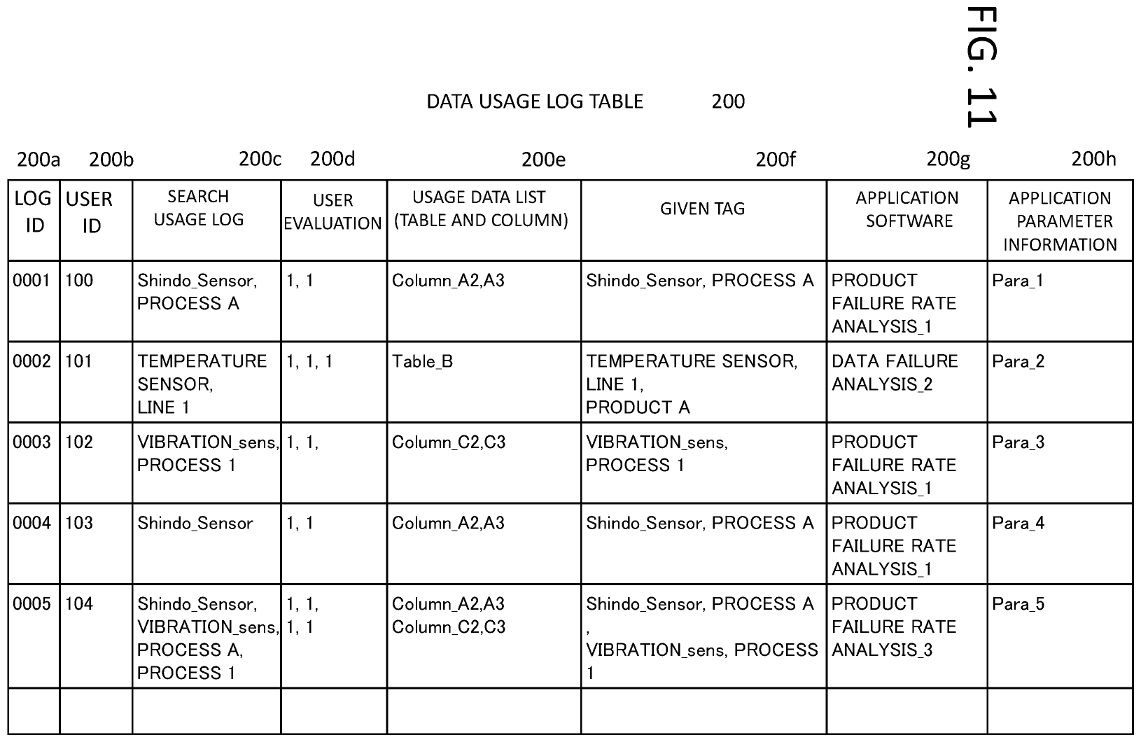

Next, a data structure handled by the tag domain presentation device according to the present embodiment will be described with reference to FIGS. 11 to 18.

A data usage log table 200 is a table that stores the log information when the data is searched and the information on how the data has been used for the application software. As shown in FIG. 11, the data usage log table 200 includes the respective columns of a log ID 200a, a user ID 200b, a search usage tag 200c, a user evaluation 200d, a usage data list 200e, a given tag 200f, application software 200g, and application parameter information 200h. The data usage log table 200 is stored in the data usage log store 21 of the tag domain presentation device 10.

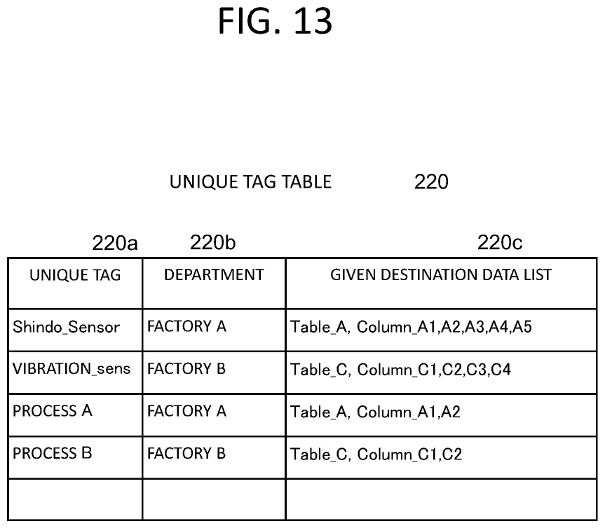

The log ID 200a stores an identifier that uniquely identifies the record. The user ID 200b stores an identifier of the searched user. The search usage tag 200c stores a tag used when searching by user-activated application software. In this case, for example, in the record with log ID 200a of “0001”, when “Shindo_sensor” and “process A” are listed, searching is performed under an AND condition of Shindo_sensor” and “process A”. The user evaluation 200d is stored with a flag obtained when the user evaluates the consistency between the data handled when the user searches and uses data and a unique tag given to the data in correspondence with the given tag listed in the given tag 186 (“1” when consistent, “0” when not consistent). The usage data list 200e is stored with information on data used by the application software in the searched data. In the present embodiment, as an example, the data is in a table format and stores a table name and a column name, but a file name and information indicative of a storage place of the storage may be stored. The given tag 200f is stored with a unique tag assigned to the data stored in the usage data list 200e based on the unique tag table (described later in FIG. 13). In this case, for example, in the record of the log ID 200a of “0001”, when “Shindo_sensor” and “poses A” are listed, both of “Shindo_sensor” and “process A” are defined as a given tag in both of “Column_A2” and “Column_A3” listed in the usage data list 200e. The application software 200g is stored with the name and ID related to the application software searched using the tag. The application parameter information 200h is stored with parameter information when the application software is started.

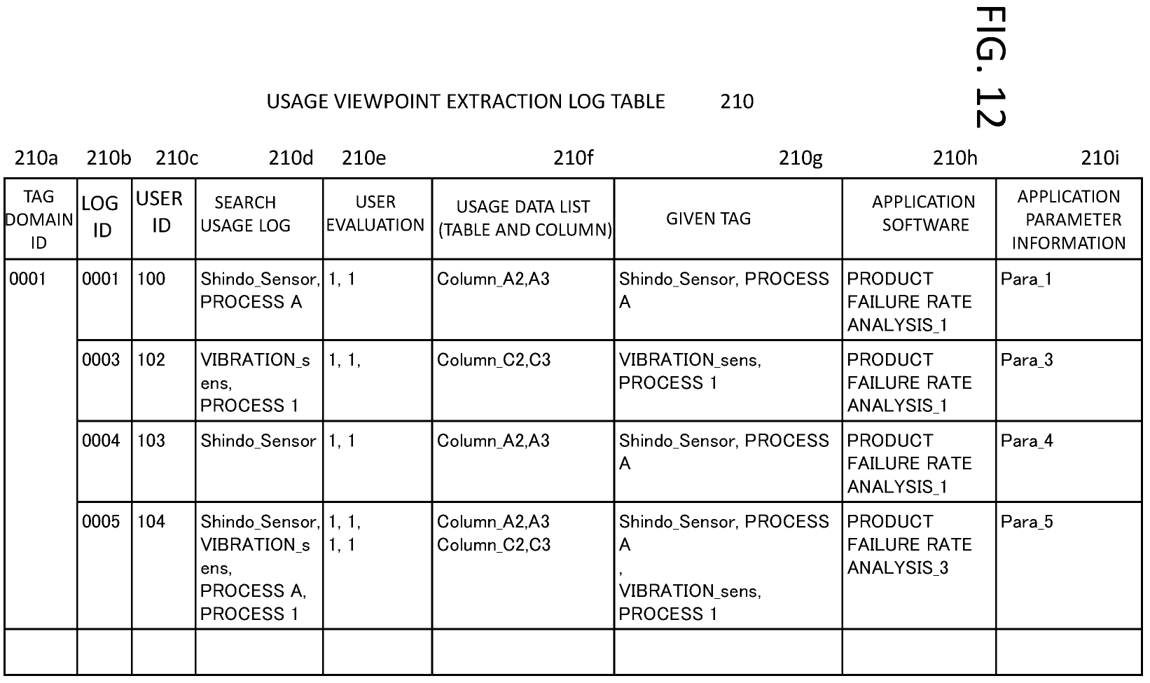

The data usage log table 200 is a table that has information on all data usage logs, and is used for filtering from all data usage logs from the viewpoint of data usage to generate a usage viewpoint extraction log table (described later in FIG. 12).

A usage viewpoint extraction log table 210 is a table that is obtained by filtering the data usage log table 200 from the viewpoint of data usage in the application software. As shown in FIG. 12, the usage viewpoint extraction log table 210 includes the respective columns of a tag domain ID 210a, a log ID 210b, a user ID 210c, a search usage tag 210d, a user evaluation 210e, a usage data list 210f, a given tag 210g, application software 210h, and application parameter information 210i. The data usage log table 200 is stored in the data usage log store 21 of the tag domain presentation device 10.

The usage viewpoint extraction log table 210 is a table generated by filtering from the data usage log table 200 for each data usage viewpoint (in the present embodiment, the viewpoint of “product failure rate analysis usage”), and the column of the tag domain ID 210a is added to each column of the records filtered in the data usage log table 200. An identifier that uniquely identifies a series of tag domain groups generated for each data usage viewpoint is stored. The subsequent log ID 210b, the user ID 210c, the search usage tag 210d, the user evaluation 210e, the usage data list 210f, the given tag 210g, the application software 210h, and the application parameter information 210i are columns corresponding to the log ID 200a, the use ID 200d, the search usage tag 200c, the user evaluation 200d, the usage data list 200e, the given tag 200f, the application software 200g, and the application parameter information 200h in the data usage log table 200, respectively.

A unique tag table 220 is a table that stores information about the unique tag, and includes the respective columns of a unique tag 220a, a department 220b, and a given destination data list 220c as shown in FIG. 13. The unique tag table 220 is stored in the tag domain store 23 of the domain presentation device 10.

The unique tag 220a is stored with a target unique tag. The affiliation 220b is stored with information indicating which department an appropriate unique tag belongs to. The given destination data list 220c is stored with information of the data for which the appropriate unique tag is searched in the department.

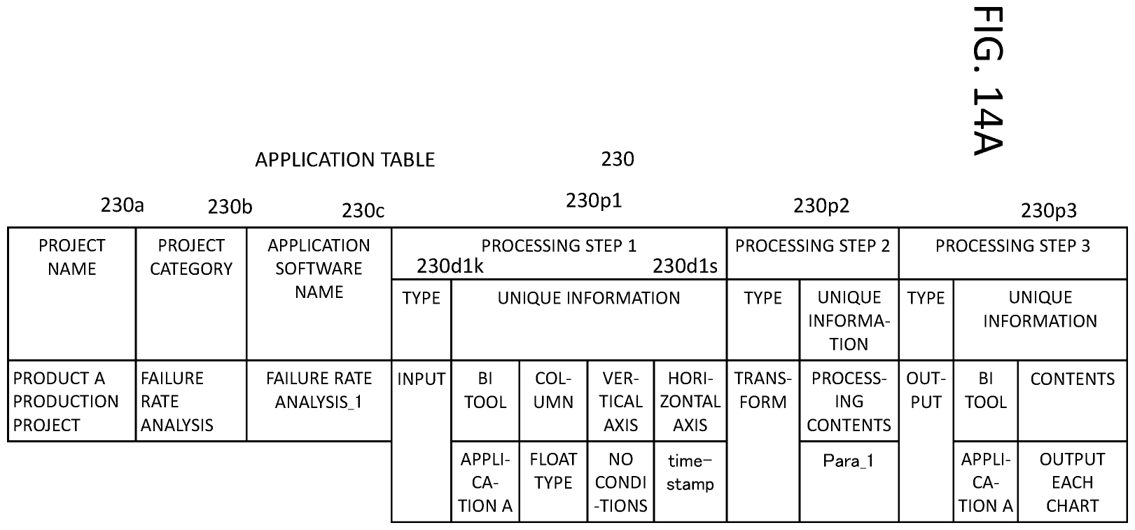

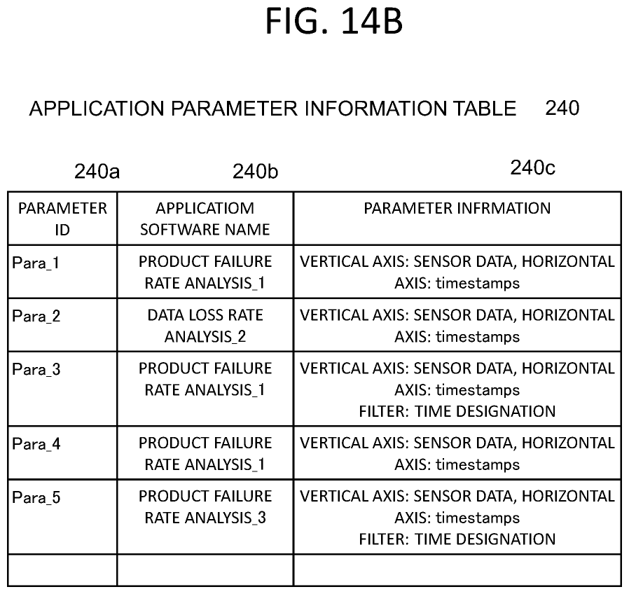

An application table 230 is a table that stores the information of the application software that uses the data searched by the tag. As shown in FIG. 14A, the application table 230 includes the respective columns of a project name 230a, a project category 230b, an application name 230a, and a processing step 230pi (i=1, 2, 3, . . . ).

The application table 230 is generated based on the application information registered in advance in the application data 70 of the application server 3, and is stored in the application management store 24 of the tag domain presentation device 10.

The project name 230a is stored with a project name in the company of a target application. The project category 230b is stored with a category name of the project in the company of the target application. In an example of FIG. 14A, the project name indicates the project of “product A production project” whereas the category name of the project indicates a failure rate analysis. The name of the target application software is stored in the application storage name 230c. The application software name 230c of the present embodiment is uniquely determined by the system. The processing step 230pi (i=1, 2, 3, . . . ) is stored with information on the processing step of the target application software.

In the processing step 230pi, each column includes a type dik and unique information dis. In the type dik, the functions in the step are stored as “input”, “conversion”, “output”, etc. The unique information dis is stored with information such as the application software to be called in the step and necessary information for a parameter to be set.

An application parameter information table 240 is a table that stores information about the parameter of the application software, and as shown in FIG. 14B, includes the respective columns of a parameter ID 240a, an application software name 240b, and parameter information 240c. In the present embodiment, the application parameters used for data analysis are extracted from the log information and stored as a history, but when the application table 230 is created, the application parameter may be defined and classified in advance in the same way.

The parameter ID 240a is stored with an identifier that uniquely identifies the parameter. The application software name is stored with the name of the application software called by the parameter. The parameter information 240c is stored with information of a specific parameter value.

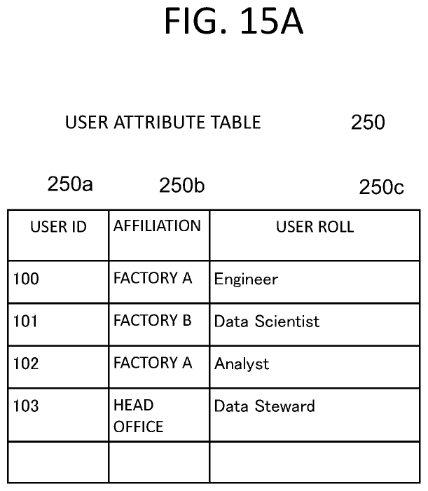

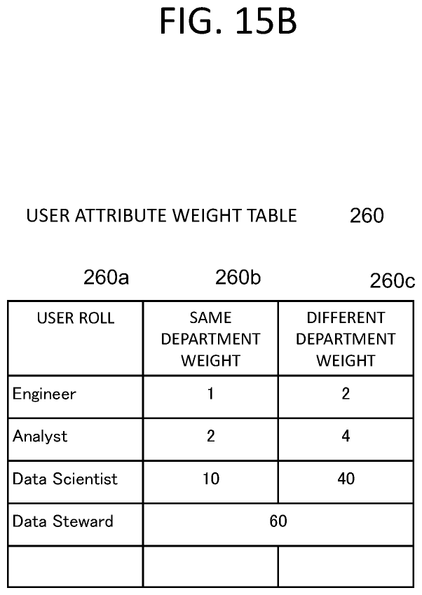

A user attribute table 250 is a table that stores the attribute of the user who uses the application software. As shown in FIG. 15A, the user attribute table 250 includes the respective columns of a user ID 250a, a department 250b, and a user roll 250c. The user attribute table 250 is used to evaluate the data usage tendency from the user attribute viewpoint based on profile information of the user acquired from the authentication data store 63 held by the data lake management server 40 (details will be described later). The user attribute table 250 is stored in the user attribute table 22 of the tag domain presentation device 10.

The user ID 250a is stored with a unique identifier that identifies the user. The department 250b is stored with the name of the department to which the user belongs. The user roll 250c is stored with information indicative of the role of the user in the corporate entity.

A user attribute weight table 260 is a table that holds the user attribute weight for each user roll to be used to calculate the user evaluation in the tag domain, and as shown in FIG. 15B, the user attribute weight table 260 includes the respective columns of a user roll 260a, the same department weight 260b, and a different department weight 260c.

The user roll 260a is stored with a name representing the role of the user similar to the user roll 250c of the user attribute table 250. The same department weight 260b and the different department weight 260c are stored with a weighted value for the user evaluation according to whether the unique tag for evaluating the tag domain is in the same department or in the different department.

The same department 242 and the different department 243 change the weight of the department for which the unique tag is defined, depending on whether the user belongs to the same department or a different department. In the present embodiment, the user attribute weight is defined in advance by the administrator, but the weight may be changed according to a user tendency. In the present embodiment, the evaluation by the user of the different department is increased, but the weight may be changed by the input of the administrator. In the present embodiment, the weight of each user attribute is calculated as a relative value when the one with the smallest value is 1. For example, the weight of each attribute is calculated as an inverse ratio of an abundance ratio of each user roll (that is, the weight of “Data Steward” (data administrator) in which the number is small in the company is increased).

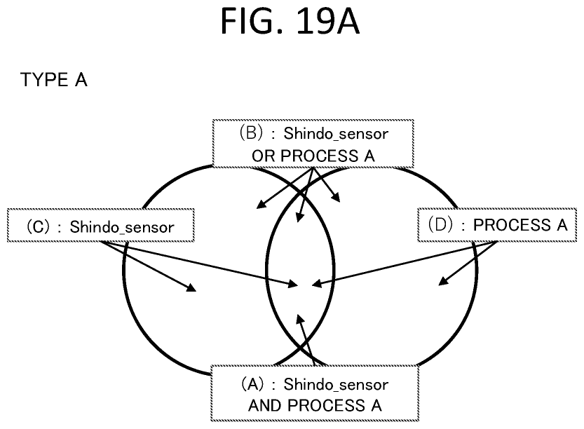

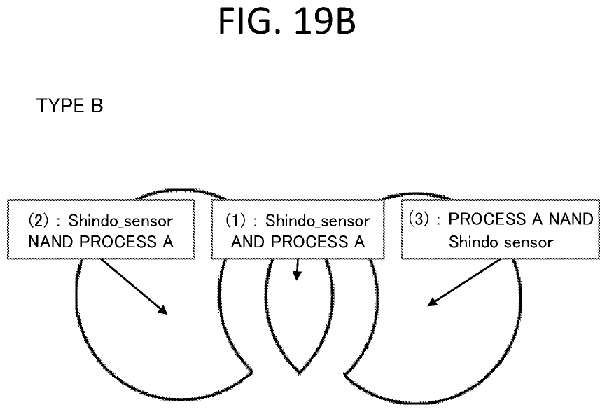

Now, before description of the usage tendency evaluation table, the tag domain recommended table, and the recommended tag domain table, the type of area division of the tag domain used in those tables will be described with reference to FIGS. 19A and 19B.

In the case of the usage viewpoint extraction log table 210 shown in FIG. 12, “Shindo_sensor” and “Process A” exist as the given tags 210g of the department “Factory A”.

In this case, in the present embodiment, as the tag domain determination type, a type A as shown in FIG. 19A and a type B as shown in FIG. 19B are used.

In the type A, as the division of the area that configures the tag domain, there are (A): “Shindo_sensor AND process A”, (B): “Shindo_sensor OR process A”, (C): “Shindo_sensor”, and (D): “process A”.

On the other hand, in the type B, as the division of the area, there are (1): “Shindo_sensor AND process A”, (2): “Shindo_sensor NAND process A”, and (3): “process A NAND Shindo_sensor”.

The respective areas divided by the type A and the type B correspond to (A): (1), (B): (1)+(2)+(3), (C): (1)+(2)), and (D): (1)+(3).

The Type B is characterized by the fact that the division of the area is a disjoint division (direct sum division). This is to make it easier to calculate the values of the analysis belonging to each area, and is used to divide the analysis tag domain of the following usage tendency evaluation table.

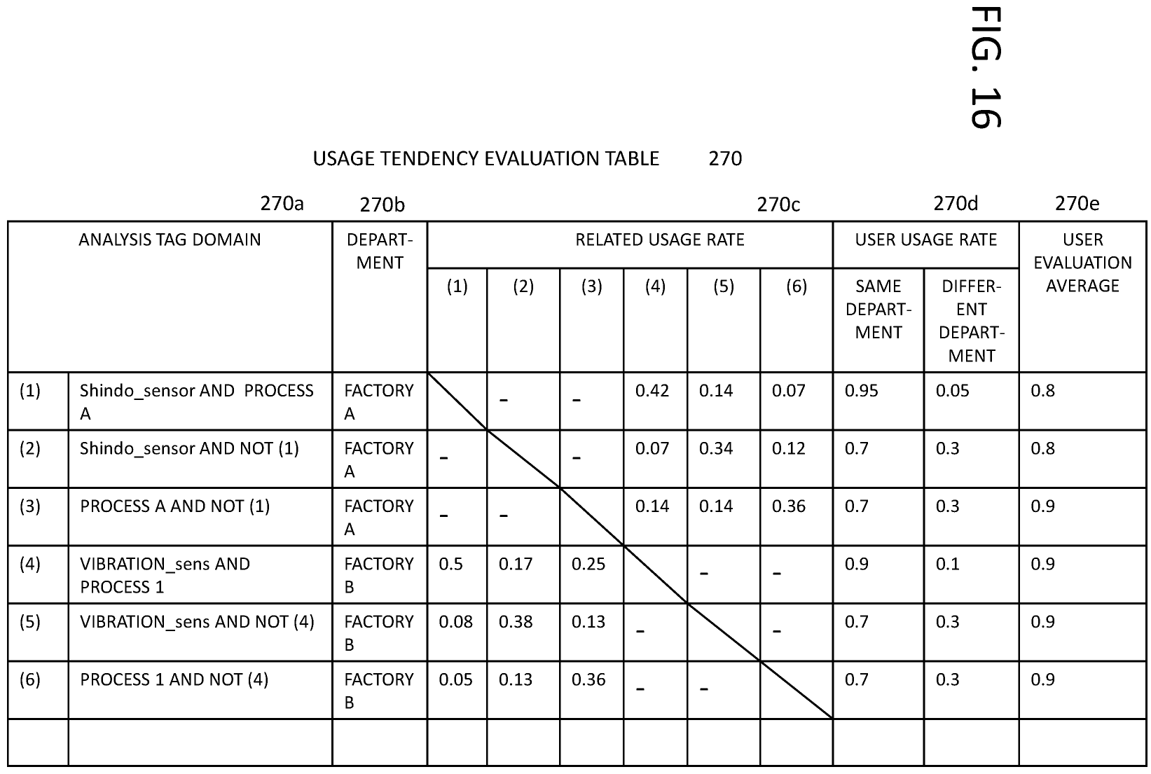

A usage tendency evaluation table 270 is a table that holds information on how the tag domain generated by the given tag is used by the application software in the usage viewpoint extraction log table 210 shown in FIG. 12. As shown in FIG. 16, the usage tendency evaluation table 270 includes the respective columns of an analysis tag domain 270a, a department 270b, a related usage rate 270c, a user usage rate 270d, and a user evaluation average 270e.

The usage tendency evaluation table 270 is a table created for each data usage viewpoint, and FIG. 16 shows an example of “product failure analysis” as a data usage viewpoint. The usage tendency evaluation table 270 is a table extracted by the usage tendency extraction unit 135 of the tag domain presentation device 10, and in a tag domain extraction process to be described later, the usage tendency evaluation table 270 is created based on the information stored in the usage viewpoint extraction log table 210, the user attribute table 250, and the unique tag table 220.

The tag domain 270a is stored with a tag domain for evaluating the usage tendency. The analysis tag domain 270a is described by the tag domain defined by the type B in FIG. 19B in the area division of the tag domain. The department 270b is stored with the department of the appropriate analysis tag domain. The related usage rate 270c is stored with the usage rate related to the application software of another tag domain for the data corresponding to one tag domain. In this example, a value defined for the analysis tag domain of row i and the related usage rate of column j is defined by the following (Equation 1). In this example, the analysis tag domain of row i is shown in FIG. 16 as (1) “Shindo_sensor AND process A”, (2) “Shindo_sensor NAND process A”, etc. of the analysis tag domain. The same applies to column j.

Value of (row i, column j) of related usage rate 270c=(number of times that the application software uses the tag domain of row i and the tag domain of column j for the data corresponding to the tag domain of row i)/(number of times that the application software uses the tag domain of row i for the data corresponding to the tag domain of row i) . . . (Ex. 1)

The user usage rate 270d is stored with a ratio of whether the data corresponding to the appropriate tag domain is used in the same department or in a different department. For example, (1) since the department of the duct main of “Shindo_sensor AND Process A” is “factory A”, when the department of the user who uses the data by the application software is “factory A”, the department is counted as the same department. At other times, the ratio counted as the different department is stored. The user evaluation average 270e is stored with an average value of the values reflecting the user evaluation 210e of the usage viewpoint extraction log table 210. At this time, calculation is performed according to the following (Ex. 2) weighted by the user attribute weight table 260 in FIG. 15 by the user who performs evaluation.

$$[ Ex . 2 ]$$

$$\frac{\sum {c}_{i} {e}_{i}}{\sum {c}_{i}} \qquad ( Ex . 2 )$$

In this example, Σ of the denominator and the numerator mean that the sum is taken over the user evaluation of the appropriate record of the appropriate usage viewpoint extraction log table 210 of the analytical tag domain, and cᵢ is a value of the same department weight 260b and the different department weight 260c in the user attribute weight table 260, which is the weight of the same department and the different department of the user of the user ID 210c of the record, and eᵢ is 0 or 1, which is a value of the user evaluation 200d of the record.

For example, as a user evaluation corresponding to a certain analysis domain, the user roll is the user evaluation “1” in the same department “Data Steward”, the user evaluation “1” in the same department “Analyst”, and the use evaluation “0” of the different department “Analyst”, and the user evaluation “1” in the different department “Engineer”, (60×1+2×1+4×0+2×1)/(60+2+4+2)=64/67≅0.96.

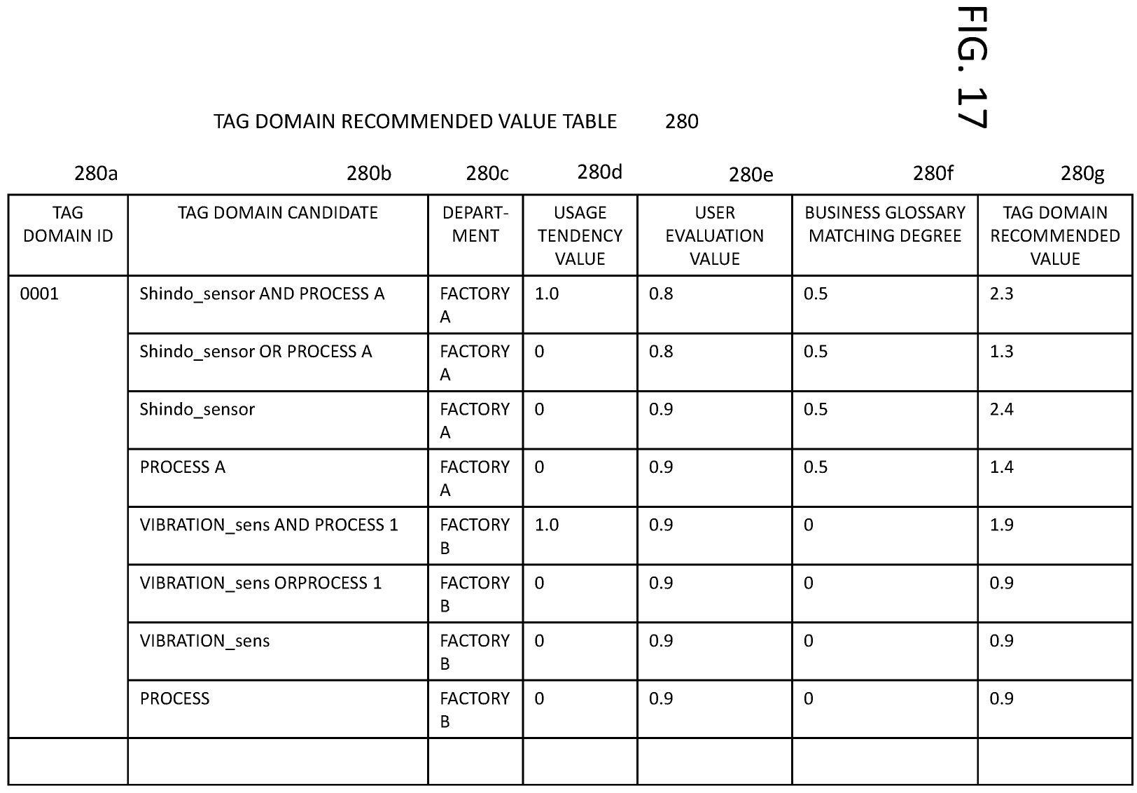

A tag domain recommended value table 280 is a table for determining a recommended value for the tag domain, and as shown in FIG. 17, the tag domain recommended value table 280 includes the respective columns of a tag domain ID 280a, a tag domain candidate 280b, a department 280c, a usage tendency value 280d, a user evaluation value 280e, a business glossary matching degree 280f, and a tag domain recommended value 280g.

A tag domain recommended value table 280 is a table created by the tag domain recommended value management unit 138 of the tag domain presentation device 10, and in a tag domain recommended value calculation process to be described later, the tag domain recommended value table 280 is a table created by use of the usage tendency evaluation table 270 and the business glossary definition (not shown). The business glossary definition is created from, for example, a set of unique tag names and given destination table columns stored in the business glossary 62 managed by the data lake management server 40.

The tag domain ID 280a is stored with an identifier that uniquely represents a candidate tag domain to be presented to the data domain administrator. The tag domain candidate 280b is stored with a candidate tag domain to be presented to the data domain administrator. The tag domain of the tag domain candidate 280b is described in the format of the type A shown in FIG. 19A. The department 280c is stored with the department of the appropriate candidate tag domain. The usage tendency value 280d is stored with a usage tendency value of the appropriate candidate tag domain based on the information of the usage tendency evaluation table 270 in FIG. 16. The details of how to obtain the usage tendency value will be described later. The user evaluation value 280e is stored with the user evaluation value of the candidate tag domain. The details of how to obtain the user evaluation value will be described later. The business glossary matching degree 280f is stored with the value of the business glossary matching degree of the candidate tag domain. The details of how to obtain the business glossary matching degree will be described later. The tag domain recommended value 280g is stored with a total value of a value of the usage tendency value 280d, a value of the user evaluation value 280e, and a value of the business glossary matching degree 280f as a comprehensive recommended value.

Next, how to obtain the usage tendency value stored in the usage tendency value 280d will be described.

The usage tendency value is a value for evaluating the usage tendency of the data corresponding to the tag domain of the user and the application software with respect to the candidate tag domain.

First, a row vector (eight dimensions in the example of FIG. 16) is generated with the values of the columns of the related usage rate 270c and the user usage rate 270d in the usage tendency evaluation table 270 in FIG. 16 as each element. The vectors corresponding to the respective analytical domains (1) to (6) are v₁ to v₆.

Next, the similarity of each vector is calculated by referring to the value of the department 270b, for example, by use of a cosine similarity. The cosine similarity is an evaluation of the similarity using a formula when the cosine between vectors is expressed by an inner product. The cosine similarity between vectors v and u is expressed by the following (Expression 3). Those vectors are similar as the cosine similarity is closer to 1, and those vectors are not similar as the cosine similarity is closer to 0.

$$[ Ex . 3 ]$$

$$Cosine similarity between vectors v and u = \frac{( v , u )}{\vert v \vert \vert u \vert} \qquad ( Ex . 3 )$$

In this example, the numerator of (Expression 3) is a product of the norms of vectors v and u, and the denominator is an inner product of the vectors v and u.

For example, in the department of “Factory A”, three types of cosine similarities between v₁, v₂, and v₃ are required. In this example, when the cosine similarity between (v₁, v₂) is the largest, and the cosine similarity exceeds a predetermined threshold (for example, 0.8), the usage tendency value of the tag domain candidate ((C) “Shindo_sensor” of the type A in FIGS. 19A and 19B) corresponding to an area of an analysis tag domain (1) and an area of an analysis tag domain (2) is set as “1”, and the usage tendency value of the tag domain of the other department of “factor A” is set as “0”.

In addition, in the department of “Factory A”, when all the cosine similarities between v₁, v₂, and v₃ do not exceed the predetermined threshold value, the usage tendency value of the tag domain candidate corresponding to the analysis tag domain having the largest value in the related usage rate with the other department of “factory B” is set as “1”, and the usage tendency value of the tag domain in the other department of “factor A” is set as “0”. In the example of FIGS. 19A and 19B, since the value of the related usage rate (4) of the analysis tag domain (1) is “0.42”, the usage tendency value of “Shindo_sensor AND process A” of the tag domain candidate corresponding to the analysis tag domain (1) is set to Next, how to obtain the user evaluation value of the tag domain stored in the user evaluation value 280e will be described.

The user evaluation value is obtained by averaging a value of the user evaluation average 270c for each analysis tag domain of the usage tendency evaluation table 270 in FIG. 16 as the value of the tag domain candidate.

For example, (B) the user evaluation value of “Shindo_sensor OR Process A” is (the user evaluation value of the analysis tag domain (1)+the user evaluation value of the analysis tag domain (2)+the user evaluation value of the analysis tag domain (3))/3.

Next, how to obtain the stored business glossary matching degree in the business glossary matching degree 280f will be described.

The business glossary matching degree 280f is obtained by checking the degree of matching between a name (for example, “Shindo_sensor”, “process A” at the time of “Shindo_sensor AND process A”) of the given tag used in the tag domain candidate and a name of the tag domain defined in the business glossary as a string. For example, if there is an exact matching, the degree of matching is set to “0.5”, and if there is something that does not match, the degree of matching is set to “0”. In addition, the degree of matching between the string used in the tag domain candidate and the string of the name of the tag domain defined in the business glossary may be expressed by a numerical value from 0 to 1.

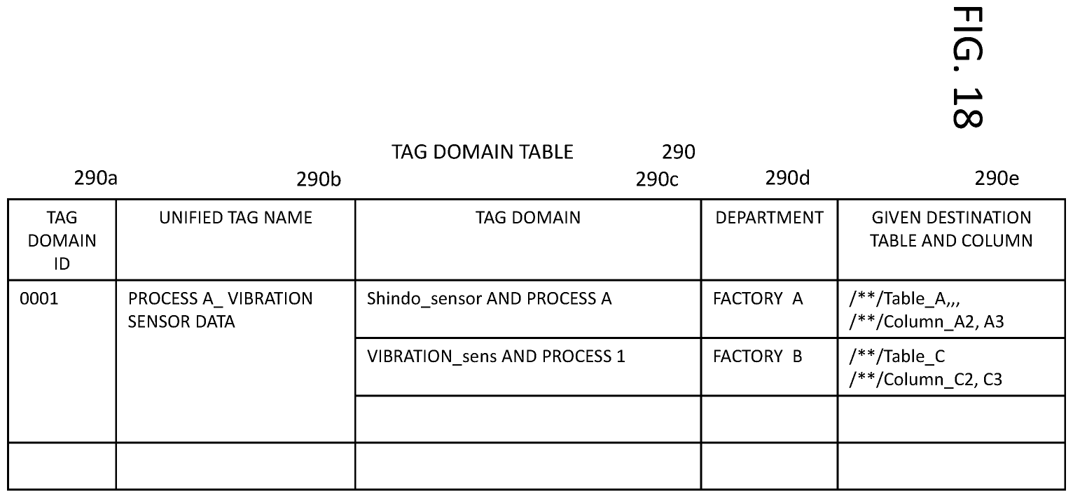

A tag domain table 290 is a table that holds information about the tag domain presented to the data administrator, and as shown in FIG. 18, includes the respective columns of a tag domain ID 290a, a unified tag name 290b, a tag domain 290c, a department 290d, and a given destination table column 290e.

The tag domain ID 290a is stored with an identifier that uniquely identifies the tag domain held in this table. The unified tag name 290b is stored with the unified tag name given to the tag domain presented by the data administrator. The tag domain 290c is stored with the tag domain for each department. The department 290d is stored with the information of the department related to the given tag that defines the tag domain. The given destination table column 290e is stored with the information about the appropriate tag domain and the corresponding table name and column.

The tag domain table 290 is generated by the tag domain management unit of the tag domain presentation device 10.

Regarding the unified tag name, after the tag domain extraction process to be described later, the candidate tag domain is presented to the administrator, and then the data administrator inputs the unified tag name given to the presented tag domain (Details of the user interface will be described later). Then, the tag domain management unit of the tag domain presentation device 10 generates the tag domain table 290 based on the unified tag name information received as input and the extracted tag domain information.

For example, in FIG. 18, as the unified tag name, an example in which “Process A_Vibration sensor data” is input from the data administrator, linked to the extracted tag domain and tag domain ID 261, and generated as the tag domain table 290.

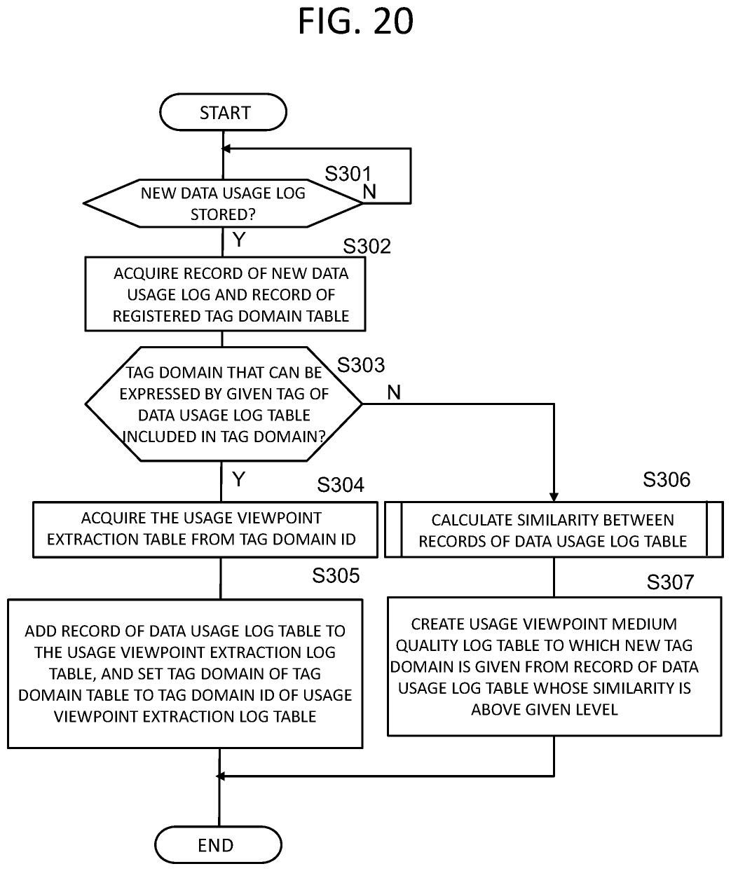

Next, the processing performed by the tag domain presentation device will be described with reference to FIGS. 20 to 24.

First, a series of processes from the accumulation of data usage logs to the presentation of the tag domain to the data lake administrator will be described with reference to FIG. 20.

When a data search, selection, and usage request is received from the data user from the data catalog management unit 42 of the data lake management server 40, the request is notified the data usage log management unit 11 of the tag domain presentation device 10.

The data usage log management unit 11 of the tag domain presentation device 10 stores the request as a new data usage log in the data usage log table 200 of the data usage log store 21 (S301: Y), and the process proceeds to S302.

Next, the tag domain management unit 13 of the tag domain presentation device 10 acquires the newly registered record of the data usage log table 200 and the registered record of the tag domain table 290 (S302).

Next, the tag domain management unit 13 of the tag domain presentation device 10 searches whether or not the tag domain that can be expressed by at least one combination of the given tags 200f of the data usage log table 200 has been registered in the column of the tag domain 290c of the tag domain table 290, in the newly registered record of the data usage log table 200.

Then, for the newly registered record of the data usage log table 200, when the tag domain 290c of the tag domain table 290 includes the tag domain that can be expressed by the combination of the given tags 200f in the data usage log table 200 (S303: Y), the process proceeds to S304, if not included (S303: N), the process proceeds to S306.

When the tag domain 290c of the tag domain table 290 includes the tag domain that can be expressed by the combination of the given tag 200f of the data usage log table 200, the usage viewpoint extraction log table 210 having the value of the tag domain of the appropriate tag domain ID 290a as a value of the tag domain ID 210a is acquired (S304).

For the newly registered record of the data usage log table 200, a record in which the value of the record of the data usage log table 200 has been copied to the log ID 210b, the user ID 210c, the search usage tag 210d, the user evaluation 210e, the usage data list 210f, the given tag 210g, the application software 210h, and the application parameter information 210i of the acquired appropriate usage viewpoint extraction log table 210 is created, and a value of the tag domain ID 290a of the tag domain table 290 is substituted for the tag domain ID 210a (S305).

When the tag domain 290c of the tag domain table 290 does not include the tag domain that can be expressed by the combination of the given tags 200f of the data usage log table 200, the similarity between the records of the data usage log table is calculated (S306).

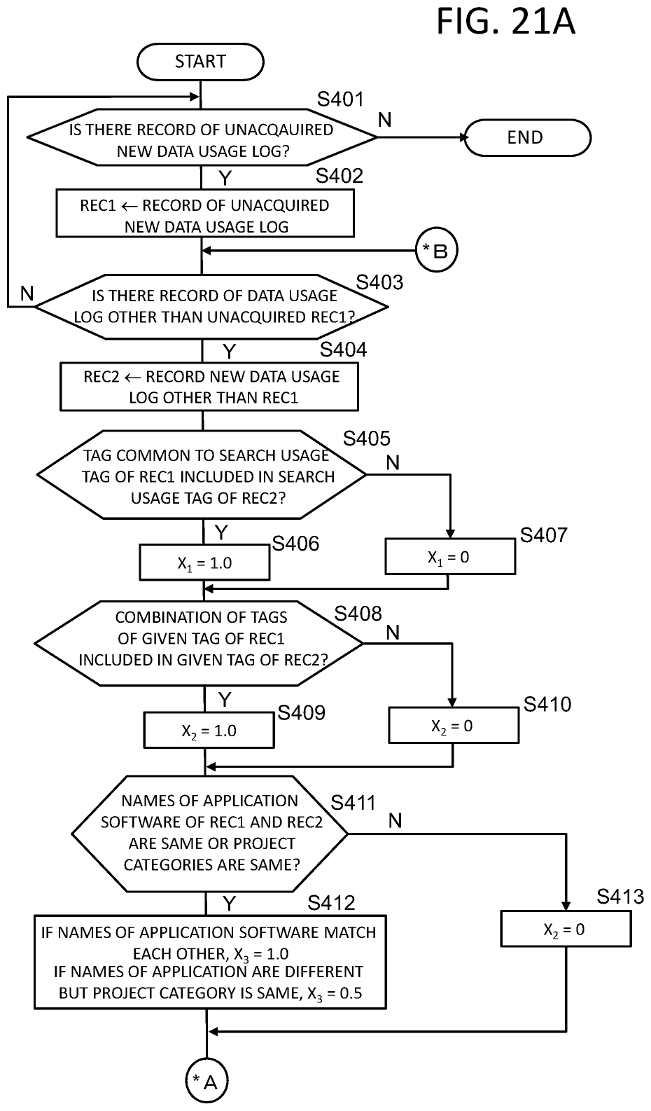

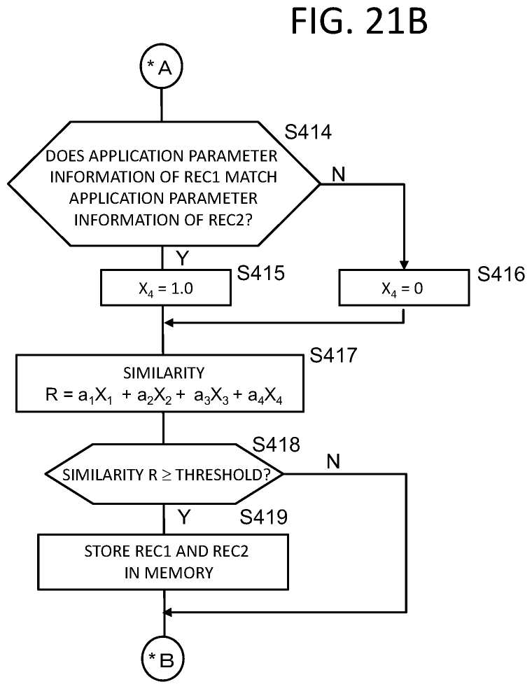

The process of calculating the similarity between records of data usage log tables will be described later with reference to FIGS. 21A and 21B.

Then, a record in which the values are copied from the record of the data usage log table 200 whose similarity is above a certain level, to the log ID 210b, the user ID 210c, the search usage tag 210d, the user evaluation 210e, the usage data list 210f, the given tag 210g, the application software 210h, and the application parameter information 210i in the usage viewpoint extraction log table 210 is created, and a value of the new ID is substituted for the tag domain ID 210a to generate a new usage viewpoint extraction log table 210 from those records (S307).

Next, the process of calculating the similarity between the records of the data usage log with will be described with reference to FIG. 21A and FIG. 21B.

This process corresponds to a process corresponding to S306 in FIG. 20, and is a process performed by the usage viewpoint extraction log table management unit 132 of the tag domain management unit 13 in the tag domain presentation device 10.

First, the tag domain management unit 13 of the tag domain presentation device 10 determines whether or not there is a record of the new data usage log table 200 that has not been acquired (S401). When there is a record of the new data usage log table 200 that has not been acquired (S401: Y), the process proceeds to S402, and when there is no record of the new data usage log table 200 that has not been acquired (S401: N), the process ends.

If there is a record of the new data usage log table 200 that has not been acquired, REC1 is set as a record of the new data usage log table 200 that has not been acquired (S402).

Next, the tag domain management unit 13 of the tag domain presentation device 10 determines whether or not there is a record of the unacquired data usage log table 200 other than REC1 (S403). When there is a record of the unacquired data usage log table 200 other than REC1 (S403: Y), the process proceeds to S404, and when there is no record of the new data usage log table 200 that has not been acquired (S403: N), the process returns to S401.

If there is a record of unacquired data usage log table 200 other than REC1, REC2 is set as a record of the unacquired data usage log table 200 other than REC1 (S404).

Next, the tag domain management unit 13 of the tag domain presentation device 10 determines whether or not the unique tag included in the search usage tag 200c of REC1 is included in the search usage tag 200c of REC2 (S405). If included (S405: Y), X₁=1.0 is set (S406), and if not included, X₁=0 is set (S407).

Next, the tag domain management unit 13 of the tag domain presentation device 10 determines whether or not the unique tag included in the given tag 200f of the REC1 is included in the given tag 200f of REC2 (S408). If included (S408: Y), X₂=1.0 is set (S409), and if not included, X₂=0 is set (S410).

In the present embodiment, the case classification is set depending on the case where the unique tag included in the given tag of REC1 is included in the given tag of REC2, but when those tags are exactly the same, the case classification is set in detail such that the given tag of REC1 is a subset of the given tag of REC2, and the value of X₂ may be determined.

Next, the tag domain management unit 13 of the tag domain presentation device 10 determines whether the name of the application software is the same name or the same project category with reference to the application software 200g of REC1 and REC2 and the application table 230 in FIG. 14A (S411).

If the name of the application software is the same name or the same project category (S411: Y), X₃=1.0 is set (S412), and if the names are different but the project category is the same (S411: Y), X₃=0.5 is set (S412), and if those conditions are not met (S411: N), X₃=0 is set (S410).

In the present embodiment, the case classification is set depending on whether the application software has the same name or is included in the application category. However, the case classification of the degree of matching and the step order for each processing step represented by the application table 230 in FIG. 14A may be set in detail to set X₃.

Next, it is determined whether the parameter information of the application software matches with each other with reference to the application parameter information 200h of REC1 and REC2 (S414). If the information matches (S408: Y), X₄=1.0 is set (S415), and if the information do not match, X₄=0 is set (S416).

In the present embodiment, the case classification is performed according to whether or not matching is performed, but X₄ may be set by setting a dictionary related to the application parameters, defining synonymous parameter groups, and calculating the degree of matching.

Next, a similarity R between REC1 and REC2 is calculated based on the above set X₁ to X₄ (S417). For the similarity R between REC1 and REC2 is calculated, for example, according to a line format with each weighted variable expressed in the following (Expression 4).

R=a₁×X₁+a₂×X₂+a₃×X₃+a₄×X₄ (Ex. 4)

In this example, a₁ to a₄ are weighting coefficients corresponding to the variables X₁ to X₄, respectively. For example, if the degree of matching of the application software is important, a₁=0.1, a₂=0.2, a₃=0.5, and a₄=0.2 are set to calculate the similarity. In the processes shown in FIGS. 21A and 21B of the present embodiment, the comparison results are weighted and calculated for each comparison item, but the weighting method and the similarity calculation method may be changed according to the configuration of the data lake.

Next, it is determined whether or not the similarity R is above a certain threshold (S418), and when the similarity R is above the certain threshold (S418: Y), REC1 and REC2 are stored in a working memory (S419).

Then, the process returns to S403.

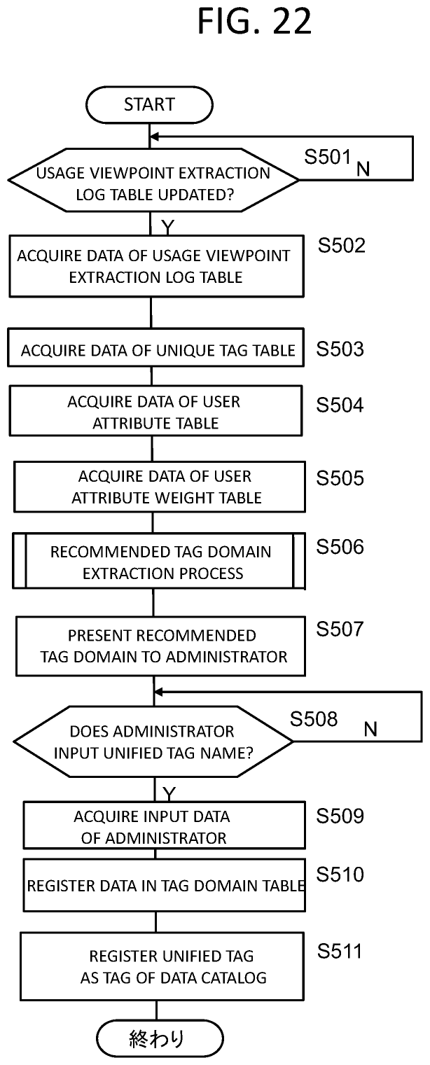

Next, a series of processes for presenting the tag domain to the data lake administrator will be described with reference to FIG. 22.

This process is performed by the tag domain management unit 13 of the tag domain presentation device 10.

First, the usage viewpoint extraction log table management unit 132 of the tag domain management unit 13 in the tag domain presentation device 10 determines whether or not the usage viewpoint extraction log table 210 has been updated (S501). If there is an update, (S501: Y), the updated data of the relevant usage viewpoint extraction log table 210 is acquired (S502).

Next, the unique tag management unit of the tag domain management unit 13 in the tag domain presentation device 10 acquires the data of the unique tag table 220 (S503).

Next, the user attribute access unit 134 of the tag domain management unit 13 in the tag domain presentation device 10 acquires the data of the appropriate user attribute table from the user attribute store 13 of the user attribute management unit 12 in the tag domain presentation device 10 (S504).

Next, the user attribute access unit 134 of the tag domain management unit 13 in the tag domain presentation device 10 acquires the data of the user attribute weight table 260 from the user attribute store 13 of the user attribute management unit 12 in the tag domain presentation device 10 (S505).

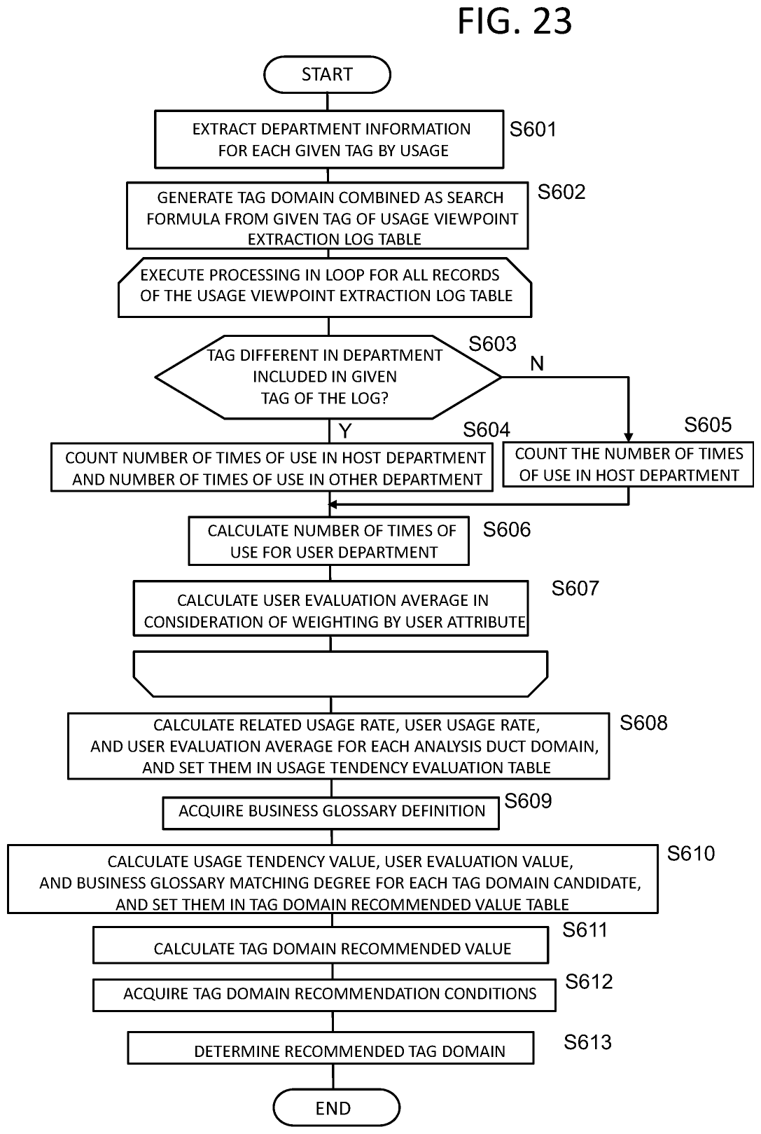

Next, the tag domain management unit 13 of the tag domain presentation device 10 executes the tag domain extraction process (S506). The details of the tag domain extraction process will be described later with reference to FIG. 23.

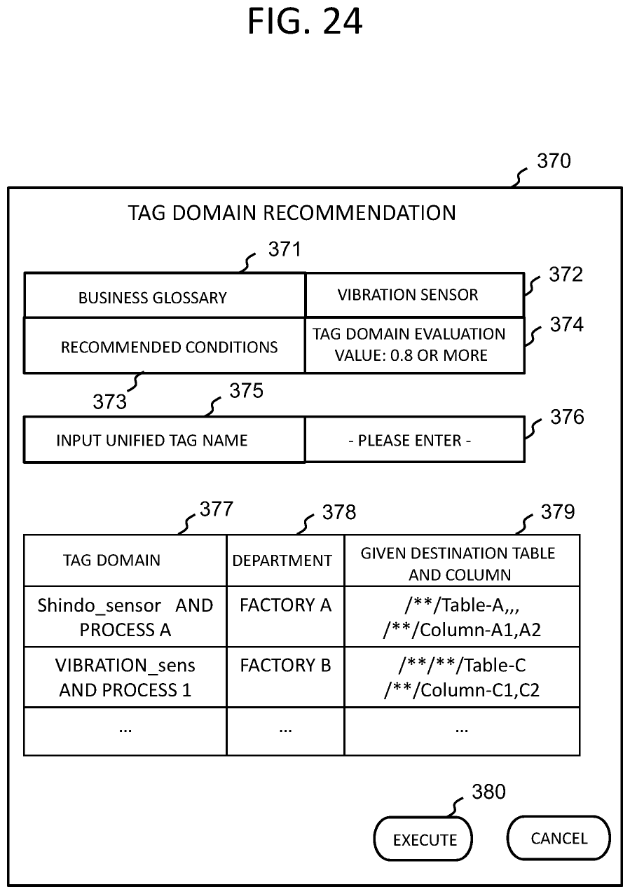

Next, the tag domain presentation device 10 transmits the recommendation result of the tag domain generated by the recommended tag domain generation unit 136 of the tag domain management unit 13 to the administrator terminal 50. The tag domain presentation unit 53 of the administrator terminal 50 displays and outputs a tag domain recommendation screen and presents the tag domain recommended to the data domain administrator (S507). The user interface of the tag domain recommendation screen will be described later with reference to FIG. 24.

Next, the tag domain presentation device 10 accepts the input of the unified tag name from the tag domain recommendation screen, and when there is an input (S508: Y), the tag domain presentation device 10 acquires the input unified tag name (S509).

Next, in S340, the tag domain presentation device 10 generates the tag domain table 290 from the value of the tag domain ID 261 from the presented tag domain and the tag domain recommended value table 280 and the data input from the tag domain recommendation screen, and registers the tag domain table 290 in the tag domain store 23 (S510).

Next, the tag domain presentation device 10 registers a new tag in the tag store 61 of the data lake management server 40 based on the given destination table column 290e of the tag domain table 290 and the unified tag name 290b (S510). As a result, general users can use the unified tag name for data search.

Next, the process of extracting the recommended tag domain will be described with reference to FIG. 23.

This is a process corresponding to S506 in FIG. 22.

First, the tag domain management unit 13 of the tag domain presentation device 10 matches the given tag 210g of the usage viewpoint extraction log table 210 with the unique tag 220a of the unique tag table 220, and extracts a value of the department 220b corresponding to the tag of the given tag 210g (S601).

Next, the tag domain management unit 13 of the tag domain presentation device 10 generates a tag domain that can be combined as a search formula from the given tag 210g of the usage viewpoint extraction log table 210 (S602). The fact that there are the type A and the type B as the method of generating the tag domain has already been described with reference to FIGS. 19A and 19B.

Next, the usage tendency extraction unit 135 of the tag domain management unit 13 in the tag domain presentation device 10 executes loop processing of S603 to S607 for each record of the usage viewpoint extraction log table 210.

First, for the record of the usage viewpoint extraction log table 210, it is determined whether or not the given tag 210g has a unique tag in a different department (S603).

As the value of the given tag of the record, if the department does not have a different unique tag (S603: N), the given tag 210g searches the analytical tag domain (type B) generated by the corresponding S601, and then one record is counted as the number of times the department has been used (S605).

If the department has a different unique tag as the value of the tag given to the record (S603: Y), the corresponding analysis tag domain is searched (type B), and in addition to counting as the number of times of use in that department, counting is made as the number of times of use in other departments.

Next, the tag domain management unit 13 of the tag domain presentation device 10 determines whether the user and the tag domain to which the used data belongs have the same departments or different departments based on the user ID 210c of the usage viewpoint extraction log table 210 and the user ID 250a of the user attribute table 250, and counts the respective departments (S606). In the present embodiment, the case classification is performed according to whether or not the department of the user and the department of the tag domain to which the data belongs match each other, but the case classification may be performed in detail with inclusion of the user roll in addition to the department.

Next, the tag domain management unit 13 of the tag domain presentation device 10 calculates a user evaluation average for each analysis tag domain based on the user evaluation 210e and the user ID 210c of the usage viewpoint extraction log table 210, and the user ID 250a of the user attribute table 250, and the value of the user attribute weight table 260 (S607). In calculating the user evaluation average, weights (same department weight 260b, different department weight 260c) for the user evaluation calculated as a relative value of the user is acquired for the value of the user evaluation 210e according to the values set in the user attribute table 250 and the user attribute weight table 260, and a user evaluation average obtained by multiplying the weights for the user evaluation by each evaluation value is calculated (refer to (Ex. 2)).

When exiting the loop, the values of the related usage rate 270c, the user usage rate 270d, and the user evaluation average 270e are calculated for the area of each analysis tag domain 270a, and set for each column of the usage tendency evaluation table 270 (S608). How to find the value of each column has already been described.

Next, in the business glossary access unit 137 of the tag domain management unit 13 in the tag domain presentation device 10 acquires the business glossary definition defined in the business glossary 62 of the data catalog server 24 (S609).

Next, the value of each usage tendency value 280d, the value of the user evaluation value 280e, and the value of the business glossary matching degree 280f are calculated for the area of the tag domain candidate 280b with reference to the value for each analysis tag domain of the usage tendency evaluation table 270, and set for each column of the tag domain recommended value table 280 (S610). How to obtain the value of the usage tendency value 280d, the value of the user evaluation value 280e, and the business glossary matching degree 280f has already been described.

Next, the tag domain management unit 13 of the tag domain presentation device 10 calculates the tag domain recommended value for each tag domain candidate 280b of the tag domain recommended value table 280, and sets the tag domain recommended value to the column of the tag domain recommended value 280g of the tag domain recommended value table 280 (S611). The tag domain recommended value for each domain a candidate 280b is a total value of the value of the appropriate usage tendency value 280d of each record, the value of the user evaluation value 280e, and the value of the business glossary matching degree 280f.

Next, the tag domain recommendation condition management unit 138 of the tag domain management unit 13 in the tag domain presentation device 10 acquires the tag domain recommendation condition set in advance (S612).

Next, the tag domain recommendation condition management unit 138 of the tag domain management unit 13 in the tag domain presentation device 10 lists a tag domain candidate 251 having the largest tag domain recommended value for each department and satisfying the acquired tag domain recommendation conditions based on the tag domain recommended value calculated for each tag domain candidate of the tag domain recommended value table 280 and the acquired tag domain recommendation conditions, and determines the tag domain candidate 251 as a recommended tag domain (S613).

Next, a user interface of the tag domain recommendation screen will be described with reference to FIG. 24.

A tag domain recommendation screen 370 is a screen displayed on the administrator terminal 50, which presents candidates for tag domains to be given a unified tag name to the data lake administrator, and accepts the input of the unified tag names.

A business glossary definition heading 371 and a business glossary value area 372 indicate that the value of a string shown in the business glossary value area 372 has already been defined in the business glossary. As an example shown in FIG. 24, the name of “vibration sensor” has already been defined in the business glossary. For example, the information is information that is presented to the data like administrator, for example, as a unified tag name for the “vibration sensor” as a hint for giving a unified tag name.

A tag domain recommendation condition heading 373 and a tag domain recommendation condition value area 374 show the recommendation conditions of the tag domain. In the example shown in FIG. 24, the tag domain recommendation condition value area 374 indicates as the conditions required for recommendation that the tag domain evaluation value is 0.8 or more, and the tag domain evaluation value 265 of the tag domain recommended value table 280 is 0.8 or more. Therefore, in this example, when all the tag domain evaluation values of the tag domain 262 of a specific department are less than 0.8, the tag domain belonging to that department is not recommended.

A unified tag name input heading 375 and a unified tag name input field 376 express waiting for the unified tag name input by the data lake administrator. In the unified tag name input field 376, “-Please enter-” is displayed on an initial screen, and the data rake administrator can enter the unified tag name determined by the administrator.

A tag domain display column 377, a department display column 378, and a given destination table column display column 379 are values corresponding to the tag domain 290a, the department 290b, and the given destination table column 290c of the tag domain table 290, respectively, and display the best tag domain that meets the recommendation conditions for each department.

The data rake administrator confirms the recommended tag domain, enters the unified tag name determined by himself/herself in the unified tag name input field 376, and then clicks an execution button 380 with a pointing device such as a mouse. As a result, the tag domain management unit 13 of the tag domain presentation device 10 stores the input unified tag name as the value of the unified tag name 290b of the corresponding tag domain table 290 for the presented tag domain and the given destination table column.

As described above, in the tag domain presentation device of the present embodiment, the usage tendency of the user and the application software using the tag is analyzed, and the common tag domain for each department (search formula of the tag defined by the tag unique to each department) is presented to the data lake administrator. As a result, the man-hours for creating the unified tag name that can be used across the departments can be reduced for the data lake administrator.

### REFERENCE SIGNS LIST

1 . . . user terminal, 4 . . . data lake, 3 . . . application server, 70 . . . application data, 5 . . . network, 10 . . . tag domain presentation device, 9 . . . network, 40 . . . data lake management server, 50 . . . administrator terminal, 60 . . . data lake accumulation data, 61 . . . tag store, 62 . . . business glossary, 63 . . . authentication data store, 200 . . . data usage log table, 210 . . . usage viewpoint extraction log table, 220 . . . unique tag table, 230 . . . application table, 240 . . . application parameter information table, 250 . . . user attribute table, 260 . . . user attribute weight table, 270 . . . usage tendency evaluation table, 280 . . . tag domain recommended value table, and 290 . . . tag domain table

1. A tag domain presentation device that presents a cross-sectoral tag search formula to each department that uses data to which a tag for searching is given,
the tag domain presentation device holding:
a user attribute table that associates a user with a department of the user;
a unique tag table that stores correspondence information between the tag and the data for each department; and
a data usage log table that stores the department to which the user belongs, information about application software for each user, a search tag used by the application software, data information corresponding to the search tag, a given tag corresponding to each data piece indicated by the unique tag table, and user evaluation information about the given tag, and
the tag domain presentation device generating a usage viewpoint extraction log table that is filtered from a data usage viewpoint by the application software from a record of the data usage log table, and generating a usage tendency evaluation table from the usage viewpoint extraction log table based on usage information about the user and the application software for each department of the data and the user evaluation information, and presenting a search formula of the tag for each department common as a data usage viewpoint based on the information of the usage tendency evaluation table.

2. The tag domain presentation device according to claim 1, wherein each tag search formula has a related usage rate indicating a mutual usage relationship rate of data corresponding to the tag search formula as a column of the usage tendency evaluation table.

3. The tag domain presentation device according to claim 1, wherein a user usage rate indicating a usage rate of the data corresponding to the tag search formula is provided for each search formula of the tag as the column of the usage tendency evaluation table.

4. The tag domain presentation device according to claim 1, wherein the user attribute table has the user and a role in a company associated with each other,
the tag domain presentation device further holds a user attribute weight table that stores a weight for each role of the user in the company, and
a user evaluation average indicating an average value of the user evaluation calculated based on a user evaluation for using the tag corresponding to the data of the usage viewpoint extraction log table and a weight of each role of the user in the company in the user attribute weight table for each tag search formula is provided for each tag formula as the column of the usage tendency evaluation table.

5. The tag domain presentation device according to claim 1,
wherein a related usage rate indicating a mutual usage relationship rate of data corresponding to the tag search expression is provided for each tag search formula as a column of the usage tendency evaluation table,
a user usage rate indicating a usage rate of data corresponding to the tag search formula for each department of the user is provided for each search formula as a column of the usage tendency evaluation table,
a usage tendency value indicating a similarity between a value of the related usage rate and a value of the user usage rate for each tag search formula is calculated,
a recommended value is calculated based on the usage tendency value for each tag search formula, and
the tag search formula for each department common from a data usage viewpoint is presented based on a recommended value for each tag search formula.

6. The tag domain presentation device according to claim 1, further comprising a unit that acquires information on the tag defined in a business glossary,
wherein the tag domain presentation device calculates a degree of matching with a business glossary that calculates a degree of matching between a string configuring the tag search formula and a string of the tag defined in the business glossary,
a recommended value is calculated based on the usage tendency value for each tag search formula, and
the tag search formula for each department common from the data usage viewpoint by the application software is presented based on the recommended value for each tag search formula.

7. A tag domain presentation method by a tag domain presentation device that presents a cross-sectoral tag search formula to each department that uses data to which a tag for searching is given, the tag domain presentation device holding:
a user attribute table that associates a user with a department of the user;
a unique tag table that stores correspondence information between the tag and the data for each department; and
a data usage log table that stores the department to which the user belongs, information about application software for each user, a search tag used by the application software, data information corresponding to the search tag, a given tag corresponding to each data piece indicated by the unique tag table, and user evaluation information about the given tag, and
the tag domain presentation device comprising the steps of:
generating a usage viewpoint extraction log table that is filtered from a data usage viewpoint by the application software from a record of the data usage log table; and
generating a usage tendency evaluation table from the usage viewpoint extraction log table based on usage information about the user and the application software for each department of the data and the user evaluation information, and presenting a search formula of the tag for each department common as a data usage viewpoint based on the information of the usage tendency evaluation table.

8. An information processing system comprising:
a data lake that holds data and a tag store with a tag attached to the data;
a tag domain presentation device that presents a cross-sectoral tag search formula to each department that uses the data of the data lake; and
a manager terminal,
the tag domain presentation device holding:
a user attribute table that associates a user with a department of the user;
a unique tag table that stores correspondence information between the tag and the data for each department; and
a data usage log table that stores the department to which the user belongs, information about application software for each user, a search tag used by the application software, data information corresponding to the search tag, a given tag corresponding to each data piece indicated by the unique tag table, and user evaluation information about the given tag, and
the tag domain presentation device generating a usage viewpoint extraction log table that is filtered from a data usage viewpoint by the application software from a record of the data usage log table; and
generating a usage tendency evaluation table from the usage viewpoint extraction log table based on usage information about the user and the application software for each department of the data and the user evaluation information, and transmitting information presenting a search formula of the tag for each department common as a data usage viewpoint based on the information of the usage tendency evaluation table to the administrator terminal through a network,
the administrator terminal displays information that presents a tag search formula for each department common as the data usage viewpoint by the application software, and a tag domain recommendation screen for inputting a unified tag name, and
the data lake registers the unified tag name input from the administrator terminal.
